(19) United States
(12) Patent Application Publication
(10) Pub. No.: US 2025/0012600 A1
(43) Pub. Date: Jan. 9, 2025

(54) AUGMENTING STANDARD DEFINITION MAP DATA WITH SEPARATE HIGH-DEFINITION MAP DATA LAYERS

(71) Applicant: Mapbox, Inc., Washington, DC (US)

(72) Inventors: Aleksandr Buslaev, Minsk (BY); Andrei Klimovich, Minsk (BY)

(21) Appl. No.: 18/765,984

(22) Filed: Jul. 8, 2024

Related U.S. Application Data
(60) Provisional application No. 63/525,635, filed on Jul. 7, 2023.

(51) Int. Cl. G01C 21/00

(52) U.S. Cl. CPC G01C 21/3848; G01C 21/3815; G01C 21/3852

(57) ABSTRACT

High-definition map data is generated from a combination of disparate data sources, such as aerial imagery, vehicle object detections, and/or vehicle telemetry data. The resulting high-definition map is sufficiently granular to support higher levels of autonomous driving systems, such as L2 and L3. In particular, specialized, expensive data sources such as LiDAR are not required for the generation of the high-definition map. Map objects are detected within aerial imagery, and vehicle object detections are clustered to filter spurious detections. The resulting detected objects are used to generate HD layers on top of other map data.

### CROSS REFERENCE TO RELATED APPLICATIONS

This application claims the benefit of U.S. Provisional Application No. 63/525,635, filed Jul. 7, 2024, which is hereby incorporated by reference in their entirety.

### FIELD OF ART

The description relates to the field of electronic maps, and more particularly to augmenting standard definition map data with high-definition map data.

### BACKGROUND

Digital electronic maps are widely used today for a number of applications, such as navigation, ride sharing, and video games, among other uses. Many conventional electronic maps, however, lack sufficient granularity to enable more advanced and/or safety-critical applications, such as autonomous navigation. For example, although many vehicles have become capable of some degree of autonomous capability (e.g., parking assist, collision detection, etc.), such “L1” features fall short of control for more complex “L2”/“L3” (or even higher “L4,” “L5,” or “L6” functionality such as steering and acceleration. Lack of sufficient granularity and accuracy within electronic map data makes such more complex functionality more difficult to achieve while also preserving occupant safety.

### SUMMARY

High-definition map data is generated from a combination of disparate data sources, such as aerial imagery, vehicle object detections, and/or vehicle telemetry data. The resulting high-definition map is sufficiently granular to support higher levels of autonomous driving systems, such as L2 and L3. In particular, specialized, expensive data sources such as LiDAR are not required for the generation of the high-definition map. Map objects are detected within aerial imagery, and vehicle object detections are clustered to filter spurious detections. The resulting detected objects are used to annotate lower definition map data sources to produce high-definition maps.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates a system environment in which the techniques described may be practiced, according to one embodiment.

FIG. 2 illustrates a client device, according to one embodiment.

FIG. 3 is a block diagram illustrating a mapping system, according to one embodiment.

FIG. 4 is a workflow diagram showing an example workflow for generating a high-definition map database, according to one embodiment.

FIG. 5 is a block diagram that illustrates a computer system upon which embodiments of components of the system environment may be implemented, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

### I. System Environment

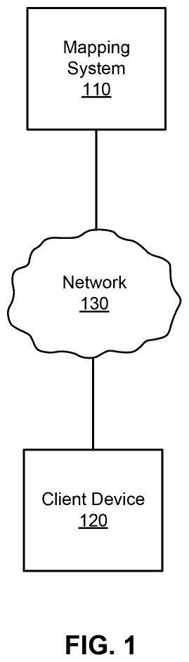

FIG. 1 illustrates a system environment in which the techniques described may be practiced, according to one embodiment.

In the illustrated example, the system environment 100 includes a mapping system 110 that provides mapping services and a client device 120 that communicates with the mapping system 110 to receive map data via a network 130. In different embodiments, the system environment 100 and its components may include different or additional elements than those illustrated in FIG. 1. Furthermore, the functionality may be distributed among the elements in a different manner than described. The system environment 100 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. The components of FIG. 1 are now described in more detail.

The mapping system 110 provides mapping services to client devices. In embodiments, the mapping system 110 provides map data to client devices for a variety of purposes, such as to display digital maps for purposes of navigation, ride sharing, or video games (e.g., a mixed reality game). In particular, the mapping system 110 provides the client device 120 with map tiles representing geographic regions, which can be used to render digital maps at various scales or resolutions, such as by stitching together a set of map tiles. For example, the client device 120 may send a request to the mapping system 110 for map tiles at a particular zoom level for a particular geographic region, and the mapping system 110 responds to the query by sending the client device 120 a respective set of map tiles, which is duly received by the client device 120.

Each map tile stored by the mapping system 110 is associated with a set of map features that may be digital representations of geographic features of the geographic region represented by the map tile, such as roads, bodies of water, public parks, buildings, or so on, and/or may be metadata corresponding to geographic features, such as textual labels, icons, symbols, or so on. The map features of a map tile are rendered by the client device 120 using corresponding vector data. The vector data of a map tile includes geometric information representing the geographic features represented by the map features, such as points (e.g., vertices), lines (e.g., edges), and shapes (e.g., polygons), which may be associated with particular geographic coordinates and/or tile coordinates (e.g., coordinates indicating a position of the map feature within the map tile). For example, a map feature may be represented by a set of vertices and edges among those vertices that collectively describe the shape of a graphical element that visualizes the map feature. The set of vertices and edges may be divided into graphical components.

The mapping system 110 may be comprised of any computing device, including but not limited to: servers, racks, workstations, personal computers, general purpose computers, laptops, Internet appliances, wireless devices, wired devices, multi-processor systems, mini-computers, virtual computing instances, and the like. Although FIG. 1 shows a single element, the mapping system 110 broadly represents one or multiple computing devices, such as a server cluster running a distributed computer program, where individual servers of the cluster may be located in one or more discrete physical locations.

The client device 120 processes the geographic information and labels of a map tile to render the map tile, which can be combined with other rendered map tiles to render an overall digital map. By rendering individual map tiles representing portions of an overall digital map, as opposed to rendering the entire digital map altogether, the client device 120 provides for efficient rendering of digital maps that can dynamically adapt to various scenarios (e.g., map scales). The client device 120 may have a client map application that uses map data from the mapping system 110, e.g., for displaying maps, or for providing navigation instructions. The client map application may additionally include modules for collecting and computing information for the generation and/or enhancement of maps as described hereinbelow.

Within the context of a mapping system 110 that provides map tiles and map data to client devices 120, the mapping system 110 may include map data at different levels of granularity (e.g., fidelity). This may be because some map-based applications, such as higher levels of autonomous vehicle control, require particularly fine-grained map information, while other map-based applications, such as a visualization of an area displayed on a client device, do not. Unfortunately, generating data having a fidelity sufficient for autonomous driving is a challenging, expensive, and time-consuming process. It requires fleets of vehicles with vast sensor arrays, traveling many hours and miles of road to develop the data sets necessary for autonomous vehicle control. Accordingly, the mapping system 110 takes map data from different sources, aggregates and conflates that data, and combines the data with SD data to generate and/or maintain a set of high definition (HD) map data. In other words, the mapping system 110 generates HD map data from various data sources, such as object detection data and/or telemetry data obtained from the various client devices 120, from aerial imagery (e.g., from a satellite), and/or standard definition map data.

The client device 120 communicates with the mapping system 110 in order to receive map data. The client device 120 may use the map data for a variety of purposes, such as rendering and displaying a digital map, or providing navigation services. In embodiments the client device 120 requests a set of map tiles from the mapping system 110 for rendering a digital map on a display of the client device 120. For instance, the client device 120 may request a set of map tiles for rendering a digital map representing a particular geographic region at one or more scales or resolutions. In this case, the client device 120 may receive the set of map tile from the mapping system 110 and stitch together the set of map tiles to render the digital map. As described in further detail below, stitching together the set of map tiles can involve determining graphical components of graphical elements constructed from vector data to visualize map features in the digital map.

The client device 120 may be any suitable computing device, such as a laptop computer, hand-held computer, wearable computer, cellular or mobile phone, portable digital assistant (PDA), kiosk, or tablet computer. Although a single client device is depicted in FIG. 1, any number of client devices may be present. The client device 120 may include a GPS receiver that receives signals describing a geographic position of the client device 120 from GPS satellites (e.g., longitude and latitude). The client device 120 includes an electronic display on which digital maps may be presented.

In some embodiments, the client device 120 executes a client map application associated with mapping system 110, such as software that displays, uses, supports, or otherwise provides electronic mapping functionality as part of the application or software. The client map application may be configured for a variety of functions involving map data, such as navigation, transportation, augmented reality, product delivery, etc. In one embodiment, the client map application obtains electronic mapping functions through an integrated software development kit (SDK) or an application programming interface (API) associated with the mapping system 110. In this case, the SDK or API may implement functional calls, callbacks, methods or other programmatic means for contacting the server computer to obtain map tiles, map tile labels, layer data, digital elevation models, or other data useful to visually render a digital map as part of the application. As an example, the client map application may identify a set of map tiles needed to render a particular geographic region (e.g., defined by a set of geographic coordinates indicating a current or upcoming viewport of the digital map at the electronic display of the client device 120) and request corresponding map tiles and/or related data (e.g., terrain data such as digital elevation models) from the mapping system 110.

The network 130 connects the mapping system 110 and the client device 120. The network 130 may be any suitable communications network for data transmission. In an embodiment such as that illustrated in FIG. 1, the network 130 uses standard communications technologies or protocols and can include the internet. In another embodiment, the entities use custom or dedicated data communications technologies.

### II. Exemplary Systems

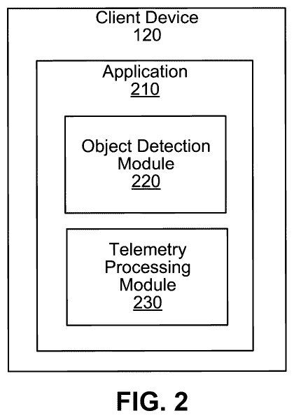

FIG. 2 illustrates a client device, according to one embodiment. In the illustrated example, the client device 120 receives map data from the mapping system 110 via a network 130. In different embodiments, the client device 120 and its components may include different or additional elements than those illustrated in FIG. 2. Furthermore, the functionality may be distributed among the elements in a different manner than described. The client device 120 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments.

The client device includes an application 210. The application 210 enables the client device 120 to use map data from the mapping system 110 for a variety of applications (e.g., displaying maps, providing navigation instructions, etc.). The client application 210 may additionally include hardware and/or modules for collecting and computing information for the generation and/or enhancement of maps (e.g., generating an enhanced map). For example, the client device 120 may include hardware such as, e.g., cameras, geolocation units (e.g., GPS), and sensors (e.g., accelerometers, inertial measurement units, etc.) that take measurements of the real-world environment surrounding the client device 120. The client device 120 can process the measurements or provide the information to the mapping system for processing, to aid in generating an enhanced map in the environment 100. Additionally, client device includes an object detection module 220 and a telemetry processing module 126 the provide functionality for enhancing a map in the environment.

The client device 120 includes an object detection module 220. The object detection module detects 220 and geolocates relevant map objects within the real world surrounding the client device 120. To do so, the object detection module 220 accesses camera data and telemetry data (e.g., as captured by a telemetry processing module 128), and identifies and locates a map object based on the camera and/or telemetry data.

The object detection module 220 obtains camera data, such as images from a video feed from a camera of the client device 120. For instance, the camera may be, e.g., a smartphone mounted on the windshield of the vehicle, a camera system integrated into the vehicle, etc. The object detection module 220 uses image processing techniques (e.g., a machine-learned object classifier, a geometric location technique, etc.) to identify map objects. Map objects are objects that have significance in a mapping context. Map objects may include, for example, edges of a road, lane markings, road line dividers, intersections, streetlights, street signs, and the like. More generally, each identified object is considered a “feature” in the real-world that may be useful in enhancing standard definition map data or providing functionality within the environment 100.

The object detection module 220 geolocates identified objects using various techniques. For example, the object detection module 220 may access a position of the client device 120 in a global reference frame, identify the object in an image, and assign a position to that object in the global reference frame using the image. To provide additional detail, some techniques for this purpose are disclosed in U.S. Pat. No. 11,282,225, which is incorporated by reference herein. The application 210 may send information on any such detected map objects—such as their types and geolocation coordinates—to the mapping system 110.

The client device 120 includes a telemetry processing module 230. The telemetry processing module 230 obtains real-time telemetry data associated with the client device 120. Telemetry data means data comprising, e.g., position, acceleration, velocity, angle, etc. of the client device 120 (and thereby a vehicle associated with that client device 120). As an example, the client device 120 may include a geolocation hardware unit. The geolocation hardware unit (e.g., a GPS device) may determine position coordinates of the client device 120 in real time (which can further be examined over time to compute direction and velocity). The application 210 sends such telemetry data to the mapping system 110.

The client device 120 (and/or the mapping system 110) may leverage the telemetry data in determining the positional information of the client device 120 and map objects (e.g., features) identified by the object detection module 220. For example, the object detection module 220 may identify an object in an image and use telemetry data to assign that identified object a position in the real world. Additionally, in some cases, the object detection module 220 may use changing telemetry data alongside a changing position of the identified object in images to locate the object in the real-world (e.g., triangulation).

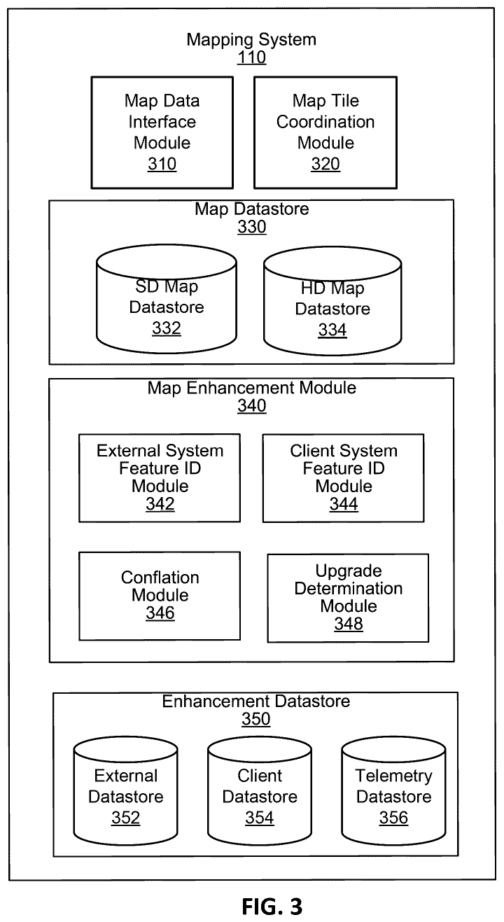

FIG. 3 is a block diagram illustrating a mapping system, according to one embodiment. In the embodiment shown, the mapping system 110 includes a map data interface module 310 that communicates with external systems or devices (e.g., the client device 120) to provide mapping services and a map tile coordination module 320 that coordinates the retrieval of map data relevant to a request from the client device 120, e.g., a set of map tiles for display on the client device 120. Additionally, the mapping system 110 includes a map datastore 330 having Standard Definition Map Datastore (“SD Map Datastore”) and High Definition Map Datastore (“HD Map Datastore”). Moreover, the mapping system 110 includes a map enhancement module 340 that coordinates augmenting SD map data with HD map data (e.g., creating HD map layers on top of an SD map or map layers). The map enhancement module 340 includes an external system feature identification module 342, a client system feature identification module 344, a conflation module 346, and an upgrade determination module 348. The mapping system includes an enhancement datastore 350 having external satellite imagery in the external datastore 352, client identified features and images in the client datastore 354, and telemetry in the telemetry datastore 356.

In different embodiments, the mapping system 110 and its components may include different or additional elements than those illustrated in FIG. 3. Furthermore, the functionality may be distributed among the elements in a different manner than described. The mapping system 110 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. The components of FIG. 2 are now described in more detail.

The mapping system 110 includes a map data interface module 310. The map data interface module 310 provides map data services to one or more computing systems (e.g., the client device 120). In particular, the map data interface module 310 receives requests for map data describing a geographic region, such as requests for a set of map tiles that can be used to render a digital map representing the geographic region at one or more scales or resolutions (e.g., by stitching together the set of map tiles). The map data interface module 310 may request map tiles from the map tile coordination module 320 that correspond to the geographic region for a particular zoom level. Responsive to receiving the requested map tiles from the map tile coordination module 320, the map data interface module 310 may provide the map tiles to the requesting system or device. The map data interface module 310 may receive a request for map data from various sources, such as another component of the mapping system 110 or from a map application on the client device 120. The map data interface module 310 may provide various interfaces to facilitate communication between the mapping system 110 and other computing systems, such as user interfaces, application programming interfaces (APIs), Software Development Kits (SDKs), and/or any other suitable interface.

The mapping system 110 includes a map tile coordination module 320. The map tile coordination module 320 interfaces with the map datastore 330 to retrieve data relevant to a data request, e.g., a request from a client device 120 ingested by the map data interface module 310 and translated into a request to the map tile coordination module 320. The map tile coordination module 320 retrieves the requested data from one or more datastores. For example, the map tile coordination module 320 generates one or more database queries and sends the database queries to one or more respective datastores, such as the map datastore 330, depending upon the embodiment. The map tile coordination module 320 receives data from one or more datastores in response to the one or more database queries. The map tile coordination module 320 sends the data to the map data interface module 310 for propagation to the client device 120.

The mapping system includes a mapping datastore 330. The map datastore 330 stores raw digital map data that is obtained, downloaded or received from a variety of sources. The raw digital map data may include satellite images, digital street data, building data, place data or terrain data. Example sources include National Aeronautics and Space Administration (NASA), United States Geological Survey (USGS), client devices 120 and DigitalGlobe. The map datastore 330 may be updated at any suitable interval, and may be stored for any amount of time. Once obtained or received, raw digital map source data stored in the map datastore 330 can be used by the mapping system 110 to generate digital map data (e.g., stored in the map datastore 330).

The map datastore 330 stores digital map data including map tiles. The digital map data may be derived from digital map source data, e.g., stored in the map datastore 330. In embodiments, the mapping system 110 processes and organizes digital map source data as a plurality of map tiles with corresponding sets of map labels or other style data used to impose different display styles for rendering the map tiles. Map data stored in the map datastore 330 may be updated (e.g., upgraded, refreshed, etc.) at any suitable interval, and may include additional information beyond that derived from digital map source data in the map datastore 330. For example, using aggregated telemetry data, external data, and client data, discussed below, various additional information may be stored in association with or added to the map tiles, such as traffic patterns, turn restrictions, detours, common or popular routes, speed limits, new streets, and any other information related to digital maps or the use of digital maps.

Additionally, the map datastore 330 may store map data as one or more layers of map data. For example, map datastore 330 may store the roadway elements of a map as a base layer of map data, and may include additional layers that represent, e.g., directionality of roadways, speed limits, traffic conditions, etc. The data structure of layered map data, therefore, provides the ability to segregate different types of data (e.g., for different functions), while simultaneously providing, in aggregate, a more complete representation of a geographic area.

Moreover, the map datastore 330 can include both SD map data (e.g., map or map layers) and separate HD map data layers. Accordingly, the map datastore 330 may include a SD map datastore 332 and an HD map datastore 334. The SD map datastore 332 stores map objects, separate map layers, map tiles, and other map-related data with a first level of fidelity and/or granularity. The HD map datastore 334 stores map objects, separate map layers, map tiles, and other map-related data with a second level of fidelity and/or granularity. In this context, the first level of fidelity and/or granularity is lower than the second level of fidelity and/or granularity, such that the map data in the HD map datastore 334 is a higher quality than map data in the SD map datastore 332. There are many ways to quantify “quality” in this context, including, e.g., feature density, number of features, types of features, error in feature position, data fidelity, data size, data age, etc. For instance, in some cases, SD map data may lack certain features present in HD data, such as road markings, barriers, lane markings, or the like, that map applications could usefully leverage. The mapping system 110 may elect to augment the SD map with HD map layers to add features lacking in the SD map data.

The different granularities of data combined with the layered structure of map data can therefore allow for providing map tiles with map layers having different layers of granularity. For example, the mapping system 110 may provide a map tile with a first SD layer representing the roadways in a geographic area, and a second HD layer providing the lane markings of the roadways in the geographic area. Additionally, the mapping system 110 may maintain the map layers such that they are separate and distinct from one another. That is, the first SD map layer is independent and different from a second HD map layer, even though the features in those map layers correspond to similar geographic areas. This enables several key features of augmenting an SD map with HD map layers. For instance, it may allow the mapping system 110 to comply with various legal requirements linked to the SD map (e.g., licenses, contracts, data privacy, local regulations and laws, etc.) while still allowing the mapping system 110 to provide higher quality information to users. Additionally, the layered structure allows the mapping system 110 to more efficiently provide map data to client devices 120 and more appropriately manage functionality within the environment 100. For instance, the mapping system 110 may include a function configured to be applied to SD map data and applying that function to HD map data would cause an error. Similarly, maintaining a distinction between SD map data layers and HD map data layers prevents cross population off SD and HD features throughout the environment 100.

The mapping system 110 includes a map enhancement module 340. The map enhancement module 340 increases the fidelity and/or granularity of a map object (e.g., a map tile) comprising map data. To do so, in an example configuration, the map enhancement module 340 adds an HD map data layer to a map object including a SD Map layer. Adding the HD map layer increases the fidelity and/or granularity (“quality”) of the map object (e.g., by increasing, overall, the fidelity of the map data relative to SD map data by adding HD map data). To do so, the map enhancement module inputs data from various sources (e.g., data in enhancement datastore 350), processes that data, and supplements the SD map data (e.g., an SD map or map layer) with the separate HD data layer to generate HD map data. This process is now described in more detail below.

The map enhancement module 340 includes an external system feature identification module 342 (“external ID module” 342). The HD data generation module 340 uses the external ID module 342 to identify features (e.g., map objects) and their geolocations using data obtained from external systems (“external data”). Data obtained from external systems may be visual data, map object data, feature maps, etc. The external ID module 342 may apply various recognition algorithms to the external data to identify features in the data. For example, the external ID module 342 may apply, e.g., a machine learned feature recognition system, a large language model, etc.

As a specific example, the external ID module 342 may access external visual data from the enhancement datastore 350. The external visual data may be, e.g., visual aerial data or satellite aerial data of a geographic area. The external ID module 342, in turn, applies a feature recognition module to the aerial and/or satellite data to identify features and their geolocations using the data. The external ID module 342, therefore, inputs external data representing an area and outputs a data set pertinent to generating HD map data for that area. That data set includes, e.g., the feature, the feature label (e.g., road sign, lane divider, lane lines, etc.), and the geolocation of the feature.

In some embodiments, the external ID module 342 preprocesses the external data. To do so, the external ID module 342 may apply any number of functions that increases the fidelity of the external data. For instance, the external ID module 342 may utilize aerial imagery of an area of interest. In this case, the external ID module 342 preprocesses that imagery to generate high-quality images, trains a deep neural network using a training dataset that comprises a set of annotated HD map elements and corresponding aerial imagery, validates the trained deep neural network using a validation dataset that comprises a set of annotated HD map elements and corresponding aerial imagery, and extracts HD map elements from the preprocessed aerial imagery using the trained deep neural network. In some embodiments, visual simultaneous location and mapping (SLAM) may also be used to increase the fidelity of external data.

The map enhancement module 340 includes a client system feature identification module 344 (“client ID module” 342). The HD data generation module 340 uses the client ID module 344 to identify features (e.g., map objects) and their geolocations using data obtained from client systems (“client data”). The client ID module 344 may accomplish this with client data in much the same way as the external ID module 342 accomplishes this with external data. That is, briefly, input client data such as images and/or telemetry data received from client devices 120, identify features and their geolocations based on the images, and output a dataset including the features.

Recall, however, that in some embodiments, a client device 120 generates features (e.g., map objects) using an object detection module 220 and provides them to the mapping system 110. In this case, the client ID module 344 inputs the features and geolocations received from a client device 120, and processes that data to determine or ensure that the detections are accurate. For example, the client ID module 344 may cluster the map object detections according to their associated geolocations received from multiple client devices (and optionally according to other data, such as object type, e.g., “road sign”) to determine a probability the cluster represents a feature. For example, a cluster might be defined based on a maximum distance between geolocations, such as 6 inches. Clusters without some minimum amount of objects in the cluster (e.g., at least some integer N, or at least some threshold fraction of the average number of objects in a cluster) are discarded.

A representative map object is generated for each remaining cluster (e.g., as the average geolocations of the map object detections in the cluster). In another example, the client ID module 344 may input the various features into a machine-learned model configured to verify features. The machine-learned model may determine a probability that one or more features and their geolocation(s) represent an actual feature. The client ID module may determine that the feature(s) is an actual feature (or features) if the probability is above a threshold probability and discard the feature(s) if the probability is below the threshold probability. Other verification processes are also possible.

The map enhancement module 340 includes a conflation module 346. The conflation module 346 determines whether features identified using different data sources are consistent. For instance, determining consistency includes evaluating whether a feature recognized from client data is the same feature recognized from external data (or a different feature, or not a feature). This determination can include, determining whether objects from one source image lie within a given small geographic distance of an object in another source image and have the same object type (e.g., a stop sign identified in two images having approximately the same geolocation), comparing the properties of the two objects (including their respective confidence scores), etc. For features identified as consistent (e.g., the same across multiple data sources), the conflation module 346 includes those features in a unified data set (representing conflated, consistent features from multiple data sources). For features identified as inconsistent, the conflation module 346 does not include those features in the unified data set.

Additionally, the conflation module 346 may use telemetry data from the enhancement datastore 350 to determine whether features are consistent. For example, if the conflation module identifies, e.g., a lane line using aerial imagery and identified features from a client system, the conflation module may determine if the lane line is consistent by comparing it to the telemetry data. To do so, the conflation module may align the telemetry data to the geolocation data for the lane lines to determine if the lane lines are an accurate representation of the lane lines in the real world (e.g., by identifying that the telemetry data is bounded by the lane lines). In other words, the conflation module 346 may be used to verify features from different sources by aligning those features to one another (e.g., lane lines and road signs) to determine if they are accurately represented and labeled.

When generating the unified data set, the conflation module 346 generates a single data object representing the feature from multiple data sources (e.g., an upgrade data object). So, for instance, for a feature identified as consistent between an external system and a client system, the conflation module 346 generates a single feature from the two. The conflation module 346 may select the feature from the disparate sources for inclusion in the unified data that is “better” than the others. In this context, “better” can be quantified in different ways such as, e.g., having a higher confidence score, having a most recent recording date, etc. In some cases, the conflation module 346 may generate a feature from the different representations of the feature across different data sources (e.g., an average geolocation).

The map enhancement module 340 generates HD map data using the unified data. To do so, the map enhancement module 340 can create, or update, HD map layers. The HD map layers, as described above, are always separate and distinct from the SD map layers. Notably, in this situation, the distinction between SD map layers and HD map layer may rest on their relative levels of granularity. As such, creating or generating separate HD map layers may be viewed as adding (relatively) higher definition map data to a map or map layer, or replacing standard definition map data with (relatively) higher definition map data to a map object. That is, in general, the map enhancement module 340 generates HD map data (e.g., layers) that is higher fidelity than the SD map data. In this way, the mapping system 110 is able to “bootstrap” existing map data in the map datastore to higher levels of data. With the unified data generated by the conflation module 346, the map enhancement module 340 supplements the SD map data with the unified data to produce the HD map data.

As a specific example, the map enhancement module 340 may generate an HD map layer that may be created by adding polygons with lane lines on to of the SD map layers without those lane lines. So, for instance, a map tile may include SD map data in a layer that represents the roads but does not include a subdivision of the road into different lanes. The map enhancement module 340 may add unified data representing those lane lines as a HD map layer to the map tile, thereby generating the HD map data. In other words, the unified data is the data used to generate an HD map layer for an SD map. In doing so, the map enhancement module 340 may verify that the identified road lines are correct by aligning them with other map objects. So, overall, the map enhancement module 340 uses data from external systems and client systems to identify and align features for upgrading standard definition map data to high-definition map data.

Because the data collection process described above is relatively inexpensive, leveraging existing aerial data, and the data obtained by existing computing devices during navigation, the data can be updated on a frequent basis, such as (for example) daily. This compares favorably with data collection methods relying on comparatively expensive technologies such as LiDAR-equipped vehicles, which due to its expense can only be collected comparatively infrequently (e.g., monthly), resulting in more up-to-date data that more quickly reflects changing conditions. Additionally, because satellites and conventional vehicles in the aggregate cover the vast majority of roads, the coverage of the HD map database that is generated from this data is much more comprehensive than that of maps generated using more expensive data collection techniques.

To that end, the map enhancement module 340 includes an upgrade determination module 348. The map enhancement module uses the upgrade determination module 340 to control, at a high level, upgrading the map data by, e.g., creating an HD layer for a map, or replacing SD or HD map data in a layer with relatively higher resolution map data. The upgrade determination module 340 may do so in a variety of manners, some of which are described hereinbelow.

In an example, the mapping system 110 may provide map tiles or map data to client devices 120 using a standardized map data density (e.g., quality or fidelity). In this case, the upgrade determination module 348 may only generate HD map data (e.g., one or more HD map layers) if the map includes layers having less than the standardized density. For example, if a map includes only those layers and information at a density required for L1 automation, the upgrade determination module may generate map layers having the density that required for L2 (or higher) automation. Moreover, the upgrade determination module 348 may only provide instructions to client devices 120 to collect additional higher fidelity data in those areas where there is only lower-level data.

In an example, the mapping system 110 may generate HD map data (e.g., one or more HD map layers) at the instruction of an administrator of the mapping system 110. For example, the administrator of the mapping system 110 may identify a desired fidelity for the mapping system 110 to provide map data to client devices 120. However, the current fidelity of the mapping system 110 is less than the desired fidelity. As such, the upgrade determination module 348 begins the process of generating HD map layers in order to bring map data in the map datastore 330 to the desired fidelity.

In an example, the mapping system 110 may generate HD map data (e.g., one or more HD map layers) order to match the data fidelity of one or more external systems. For instance, the mapping system 110 may ingest a first set of map data at a first fidelity (e.g., necessary for L2 automation) and a second set of map data at a second fidelity (e.g., necessary for L3 automation). In this situation, it would be detrimental to provide map data with different fidelities to client devices 120. In turn, the upgrade determination module 348 may increase the fidelity of the first set of map data to that of the second set of map data (e.g., by replacing data or generating a new HD layer that augments data in that layer).

In an example, the mapping system 110 may generate HD map data (e.g., one or more HD map layers) after an amount of time. For example, the upgrade determination module 348 may elect to increase the fidelity of map data in the map datastore after a threshold period of time, at a regular frequency, etc.

Additionally, the upgrade determination module 348 may control how external and/or client data is collected when generating HD map data (e.g., HD map layers) map data from SD map data to HD map data. For example, the upgrade determination module 348 may instruct client devices to only collect data in areas where map data corresponding to that area is less than the desired fidelity. Moreover, the upgrade determination module 348 may instruct client devices to collect only a threshold amount of data (e.g., enough to upgrade the fidelity of the map data). Further, the upgrade determination module 348 may instruct one or more client device to 120 to acquire data in areas where there is insufficient data. Similar processes may occur for external systems.

The mapping system 110 includes an enhancement datastore 350. The enhancement datastore 350 includes various data and datastores utilized by the map enhancement module to generate HD map data (e.g., HD map layers). As illustrated, the external datastore includes the external data received from the external system. External data may include aerial imagery, satellite imagery, feature maps, map data, map tiles, etc. The aerial imagery and or satellite imagery includes image data taken from a vantage point above the road system that the maps represent, such as image data obtained from geosynchronous satellites, or from unmanned aerial vehicles. Client datastore may include the client data received from client systems (e.g., client devices). Client data may include identified features, images, geolocations, etc. That is, the client datastore 354 stores map object outputs of the object detection module 220 of the client devices 120. The telemetry datastore 336 includes telemetry data received from client devices. In an example, the enhancement datastore 350 does not include LiDAR data and the map enhancement module does not leverage LiDAR data to upgrade map data.

Different types of external data and/or client data may be utilized for identifying different features (e.g., map objects) because that data source excels at identifying that feature. For instance, aerial images from an external source may excel at identifying lane lines, while they may be less capable at identifying, e.g., road signs (because they are vertical). Similarly, an external map data object may be excellent at identifying a street address (because its labelled with such) but is less beneficial for identifying lane lines. Client system data, similarly, may be useful in identifying certain features relative to others. In this manner, the map enhancement module 340 can leverages data sources to identify different features such that map tiles generated from the aggregated data sources have higher fidelity than any one source (because it can identify more features).

### III. Exemplary Processes

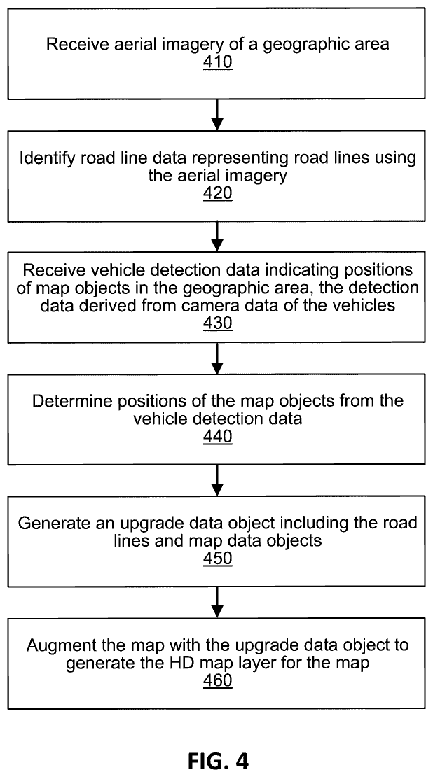

FIG. 4 is a workflow diagram showing an example workflow for generating a high-definition map database, according to one embodiment. In the illustrated workflow, additional or fewer steps may be included, and the steps may occur in a different order. Moreover, one or more of the steps may be omitted or repeated.

In the workflow, one or more client devices (e.g., client device 120) and a mapping system (e.g. mapping system 110) communicate with one another in a system environment (e.g., environment 100). The client device 120 may represent an autonomous vehicle or a client device associated (e.g., present in) an autonomous or semi-autonomous vehicle. The mapping system includes a map datastore (e.g., map datastore 330) including two data formats-a standard definition data format and a high-definition data format. The standard definition data format is in a first, base layer of maps in the map datastore, and the high-definition data format is in a second, different layer of maps in the datastore. In some cases, one or more of the maps may only including SD map data, and the mapping system is generating new map layers for all of the geographic areas.

The standard definition data format has a fidelity sufficient for L1 autonomous navigation and the high-definition data format has a fidelity sufficient for L2 autonomous navigation (or, L3, L4, L5, or L6 autonomous navigation). Unfortunately, the high-definition map data does not cover as many geographic areas as the standard definition map data such that L2 autonomous navigation is less available than L1 autonomous navigation. In turn, the mapping system determines to generate HD map layers in order to augment maps having the SD map layers with additional features. The additional features used to generate HD map layers are received from client devices and external sources, and those features to produce additional high-definition map data (e.g., high-definition map layers).

To do so, the mapping system receives 410 external data from external systems for a geographic area (that has merely standard definition map data). For instance, the mapping system receives aerial imagery of the geographic region. The aerial imagery comprises image data representing features that can be used to generate HD map layers for maps including SD map layers. For instance, the aerial imagery may include image data representing road lines in the geographic area.

The mapping system identifies 420 features in the geographic area using the aerial imagery. For example, the mapping system identifies road line data representing road lines in the geographic area using the aerial imagery. For instance, the mapping system may apply one or machine learned models to the aerial imagery to both identify (e.g., classify) and geolocate (e.g., provide positional data) the road lines in the geographic area.

Because the mapping system decided to enhance the standard definition map data to high-definition map data, various client devices in the geographic area are collecting client data. The client data includes information representing various features in the geographic area (e.g., map objects such as road signs, buildings, etc.). The client system may apply one or more machine learned models to the identify and geolocate the various map objects. In some cases, the client system may also measure telemetry data and use the telemetry data in identifying features in the images. The client devices transmit the identified features to the mapping system and the mapping system receives 430 the identified features (e.g., positions and classifications of map objects) from the client devices.

The mapping system determines 440 the positions of the map objects received from the client devices. To do so, the mapping system may apply one or more models or functions to the received map objects. For instance, the mapping system may apply a clustering function to the identified objects to determine their positions.

The mapping system generates 450 an upgrade data object. The upgrade data object includes a representation of the road lines identified from aerial imagery and the map objects identified from the client devices. In some cases, the map objects are aligned to the road line data. The upgrade data object generates one or more layers having HD map data in maps having one or more layers having SD map data.

The mapping system augments 460 the map with the upgrade data object. The upgrade data object may either (1) generate a new HD map layer for the map, or (2) replace (relatively) lower fidelity map data in different layer. In some cases, the mapping system may not replace map data in a base layer, and may only replace map data in other, distinct layers (e.g., already existing HD layers). The augmented map generally includes both standard definition layers and high-definition layers, and those layer represent the geographic area at different levels of fidelity.

### IV. Example Computer System

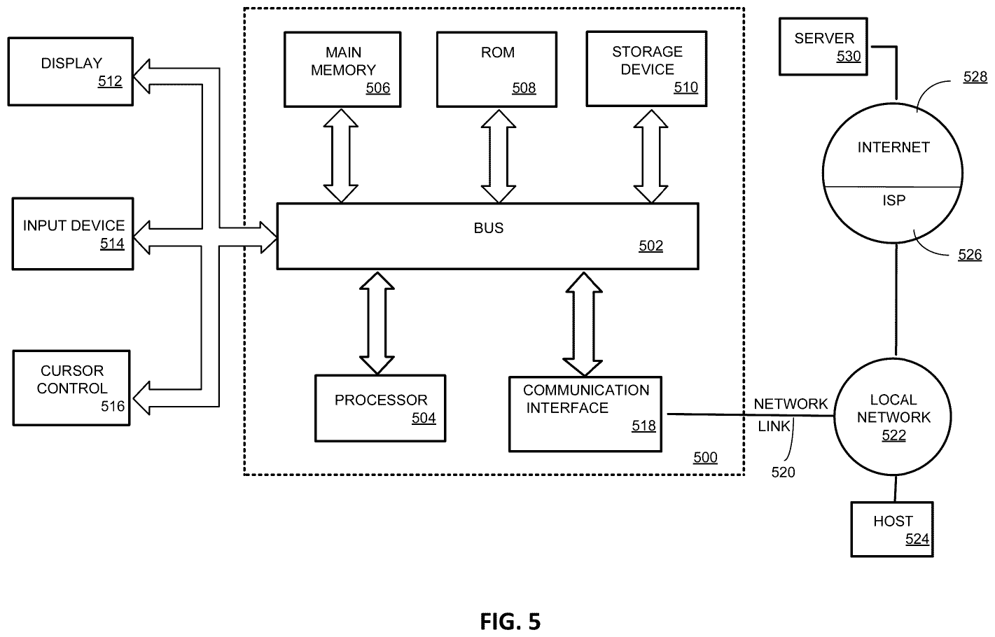

FIG. 5 is a block diagram that illustrates a computer system 500 upon which embodiments of components of the system environment 100 may be implemented. Computer system 500 includes a bus 502 or other communication mechanism for communicating information, and a hardware processor 504 coupled with bus 502 for processing information. Hardware processor 504 may be, for example, a general purpose microprocessor.

Example computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a LCD screen, LED screen, or touch screen, for displaying information to a computer user. An input device 514, which may include alphanumeric and other keys, buttons, a mouse, a touchscreen, or other input elements is coupled to bus 502 for communicating information and command selections to processor 504. In some embodiments, the computer system 500 may also include a cursor control 516, such as a mouse, a trackball, or cursor direction keys for communicating direction information and command selections to processor 504 and for controlling cursor movement on display 512. The cursor control 516 typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and instructions that cause a machine to operation in a specific fashion. Such storage media may comprise non-volatile media and volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic, radio, or light waves, such as those generated during radio-wave and infra-red data communications, such as WI-FI, 3G, 4G, BLUETOOTH, or wireless communications following any other wireless networking standard.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and stored in storage device 510, or other non-volatile storage for later execution.

### V. Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

As used herein, any reference to “one embodiment” or “an embodiment” means that a particular element, label, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs that may be used to employ the described techniques and approaches. Thus, while particular embodiments and applications have been illustrated and described, it is to be understood that the described subject matter is not limited to the precise construction and components disclosed. The scope of protection should be limited only by the following claims.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A computer-implemented method for producing a high-definition map layer for a map of a geographic area in a map database, the map including a standard definition map layer, the computer-implemented method comprising:
receiving aerial imagery of the geographic area;
identifying, using the aerial imagery, road line data representing road lines in the geographic area;
receiving, from a plurality of computing devices in a corresponding plurality of vehicles, vehicle detection data indicating positions of map objects in the geographic area, the vehicle detection data being derived by the plurality of computing devices from camera data of the plurality of computing devices;
determining the positions of the map objects from the vehicle detection data;
generating an upgrade data object representing the road lines and map objects by aligning the road line data and the determined positions of the map objects; and
augmenting the map with the upgrade data object representing the road lines and map object, the upgrade data object creating the high-definition map layer of the geographic area in the map, and wherein the standard definition map layer and high-definition map layer represent the geographic area at different levels of fidelity.

2. The computer-implemented method of claim 1, further comprising:
receiving telemetry data from the plurality of computing devices in the corresponding plurality of vehicles, the telemetry data comprising positions, headings, and velocities of the plurality of vehicles in the geographic area;
wherein producing the high-definition map layer comprises aligning the telemetry data with the road line data and clustered positions of the map objects.

3. The computer-implemented method of claim 1, wherein the high-definition map layer is produced without using light detection and ranging (LiDAR) data.

4. The computer-implemented method of claim 1, wherein the map objects are road signs.

5. The computer-implemented method of claim 1, wherein producing the high-definition map layer is in response to a mapping system determining to increase the fidelity of the map relative to the fidelity of the standard definition map layer.

6. The computer-implemented method of claim 1, wherein the standard definition map layer has a first fidelity necessary for L1 autonomous driving and the high-definition map layer has a second fidelity higher than the first fidelity necessary for L2 or higher autonomous driving.

7. The computer-implemented method of claim 1, wherein determining the positions of the map objects from the vehicle detection data comprises clustering the objects across the vehicle detection data to identify consistent map objects.

8. The computer-implemented method of claim 1, wherein the vehicle detection data is determined by:
applying, using a computing device of the plurality of computing devices, a machine learned model to the camera data of that computing device to identify the map object; and
identifying a geolocation of the map object using telemetry data of the computing device.

9. The computer-implemented method of claim 1, further comprising increasing a fidelity of the aerial imagery by applying one or more processing functions before identifying road lines in the aerial imagery.

10. The computer-implemented method of claim 1, further comprising instructing the plurality of computing devices to collect vehicle detection data in the geographic area when a fidelity of a map representing the geographic area is less than a desired fidelity.

11. A non-transitory computer-readable storage medium storing computer program instructions for producing a high-definition map layer for a map of a geographic area, the computer program instructions, when executed by one or more processors, causing the one or more processors to:
receive aerial imagery of the geographic area;
identify, using the aerial imagery, road line data representing road lines in the geographic area;
receive, from a plurality of computing devices in a corresponding plurality of vehicles, vehicle detection data indicating positions of map objects in the geographic area, the vehicle detection data being derived by the plurality of computing devices from camera data of the plurality of computing devices;
determine the positions of the map objects from the vehicle detection data;
generate an upgrade data object representing the road lines and map objects by aligning the road line data and the determined positions of the map objects; and
augment the map with the upgrade data object representing the road lines and map object, the upgrade data object creating the high-definition map layer of the geographic area in the map, and wherein the standard definition map layer and high-definition map layer represent the geographic area at different levels of fidelity.

12. The non-transitory computer-readable storage medium of claim 11, further comprising:
receiving telemetry data from the plurality of computing devices in the corresponding plurality of vehicles, the telemetry data comprising positions, headings, and velocities of the plurality of vehicles in the geographic area;
wherein producing the high-definition map layer comprises aligning the telemetry data with the road line data and clustered positions of the map objects.

13. The non-transitory computer-readable storage medium of claim 11, wherein the high-definition map layer is produced without using light detection and ranging (LiDAR) data.

14. The non-transitory computer-readable storage medium of claim 11, wherein the map objects are road signs.

15. The non-transitory computer-readable storage medium of claim 11, wherein producing the high-definition map layer is in response to a mapping system determining to increase the fidelity of the map relative to the fidelity of the standard definition map layer.

16. The non-transitory computer-readable storage medium of claim 11, wherein the standard definition map layer has a first fidelity necessary for L1 autonomous driving and the high-definition map layer has a second fidelity higher than the first fidelity necessary for L2 or higher autonomous driving.

17. The non-transitory computer-readable storage medium of claim 11, wherein determining the positions of the map objects from the vehicle detection data comprises clustering the objects across the vehicle detection data to identify consistent map objects.

18. The non-transitory computer-readable storage medium of claim 11, wherein the vehicle detection data is determined by:
applying, using a computing device of the plurality of computing devices, a machine learned model to the camera data of that computing device to identify the map object; and
identifying a geolocation of the map object using telemetry data of the computing device.

19. The non-transitory computer-readable storage medium of claim 11, further comprising increasing a fidelity of the aerial imagery by applying one or more processing functions before identifying road lines in the aerial imagery.

20. A system comprising:
one or more processors; and
a non-transitory computer-readable storage medium storing computer program instructions for producing a high-definition map layer for a map of a geographic area, the computer program instructions, when executed by the one or more processors, causing the one or more processors to:
receive aerial imagery of the geographic area;
identify, using the aerial imagery, road line data representing road lines in the geographic area;
receive, from a plurality of computing devices in a corresponding plurality of vehicles, vehicle detection data indicating positions of map objects in the geographic area, the vehicle detection data being derived by the plurality of computing devices from camera data of the plurality of computing devices;
determine the positions of the map objects from the vehicle detection data;
generate an upgrade data object representing the road lines and map objects by aligning the road line data and the determined positions of the map objects; and
augment the map with the upgrade data object representing the road lines and map object, the upgrade data object creating the high-definition map layer of the geographic area in the map, and wherein the standard definition map layer and high-definition map layer represent the geographic area at different levels of fidelity.
